(19) United States
(12) Patent Application Publication
(10) Pub. No.: US 2013/0056674 A1
(43) Pub. Date: Mar. 7, 2013

(54) POWDER MAGNETIC CORE AND PROCESS FOR PRODUCTION THEREOF

(71) Applicants: Takashi Inagaki, Matsudo-shi (JP); Takehiro Shimoyama, Tsukuba-shi (JP); Chio Ishihara, Katsushika-ku (JP); Tetsushi Maruyama, Tsukuba-shi (JP)

(72) Inventors: Takashi Inagaki, Matsudo-shi (JP); Takehiro Shimoyama, Tsukuba-shi (JP); Chio Ishihara, Katsushika-ku (JP); Tetsushi Maruyama, Tsukuba-shi (JP)

(21) Appl. No.: 13/640,175

(22) PCT Filed: Apr. 8, 2011
(86) PCT No.: PCT/JP2011/058936

§ 371 Date: Nov. 19, 2012

(30) Foreign Application Priority Data
Apr. 9, 2010 (JP) 2010-090679
Nov. 8, 2010 (JP) 2010-250238

(51) Int. Cl. H01F 1/01; B22F 3/12; H01F 41/02; B22F 1/02; B82Y 25/00

(52) U.S. Cl. 252/62.55; 419/35; 977/773; 977/902

(57) ABSTRACT

A powder magnetic core of the present invention is a powder magnetic core that includes an insulating layer containing a particulate metal oxide between metal powders, in which the insulating layer contains Ca, P, O, Si, and C as elements. According to the present invention, it is possible to provide a powder magnetic core in which securing of a constant permeability characteristic under a high magnetic field and decrease in core loss are compatible with each other, and a method for producing the powder magnetic core.

### TECHNICAL FIELD

The present invention relates to a powder magnetic core and a method of producing the same.

### BACKGROUND ART

In recent years, development of so-called low emission vehicles such as fuel cell vehicles, electric vehicles, and hybrid vehicles has progressed. Particularly, the hybrid vehicles have been spreading widely in and outside Japan. In these hybrid vehicles, in recent years, raising of a voltage that drives the electric motor is preferable so as to improve an output of an electric motor, and hybrid vehicles, which are provided with a voltage raising circuit that raises a voltage of a battery mounted in the hybrid vehicles, have been put into practical use. A reactor including a core (magnetic core) and coils wound around the core is provided in the voltage raising circuit.

In general, as a material of the core for the reactor, laminated silicon steel sheet, an amorphous laminated core, ferrite core, and the like may be exemplified, and the core is manufactured by lamination of a plate material, powder compression molding, powder compression sintering, or the like. In addition, sometimes, an appropriate gap is provided in a magnetic path of the core and thus an apparent permeability is adjusted so as to improve DC bias characteristics.

In addition, as a material of the core, a powder magnetic core that is manufactured by compression-molding soft magnetic metal powder of iron or the like may be exemplified. The powder magnetic core has a yield of material at the time of being manufactured, which is superior to a laminated magnetic core formed by using an electromagnetic steel plate or the like, and thus the cost may be reduced. In addition, a degree of freedom in a shape is high and thus improvement in characteristics may be achieved by performing an optimal design of the shape of the magnetic core. Furthermore, eddy current loss (core loss) may be reduced greatly by increasing an insulation property between metal powders by mixing an insulating material such as an organic resin and an inorganic powder and a metal powder or by forming an insulating layer on a surface of the metal powder, and particularly, excellent magnetic characteristics may be obtained in a high frequency area. From this reason, in recent years, a powder magnetic core has attracted attention as a soft magnetic iron core that is used in rotary electrical machinery, a transformer, a reactor, a choke coil, and the like.

As a method of manufacturing the powder magnetic core, a method in which mixed powders obtained by adding thermosetting resin powders to soft magnetic powders on which an inorganic insulating film is formed are compression-molded and the resultant compact body is subjected to a resin hardening treatment is disclosed (Patent Literature 1). In addition, in recent years, additional low core loss of the powder magnetic core has been requested. To reduce hysteresis loss, the powder magnetic core is subjected to heat treatment to mitigate strain due to powder compression molding, thereby reducing the hysteresis loss (Patent Literature 2 and the like).

### CITATION LIST

### Patent Literature

[Patent Literature 1] Japanese Unexamined Patent Application Publication No. 9-320830
[Patent Literature 2] Japanese Unexamined Patent Application Publication No. 2000-235925 [Patent Literature 1]

### SUMMARY OF INVENTION

### Technical Problem

However, in recent years, accompanying a large output of a motor, there have been demands for a core of a reactor and the like to be used at a magnetic flux density of 1.0 T or more under a high magnetic field of 10,000 A/m. In a common core, the magnetic flux density is saturated under a high magnetic field, and thus a differential permeability, which is a gradient of a tangential line of a magnetic curve, is apt to decrease. However, in the core for a reactor that is used under a high magnetic field, there is a demand for the differential permeability not to decrease even under the high magnetic field, that is, to be excellent in terms of having a constant permeability. Since a magnetic gap such as an insulating material and pore are dispersed in the powder magnetic core, a constant permeability characteristic other than under the high magnetic field is excellent, but it cannot be said that the constant permeability characteristic under the high magnetic field is excellent.

The constant permeability characteristic and the core loss of the powder magnetic core may be in a trade-off relationship. For example, in a powder magnetic core in which a resin is added as an insulating material, the maximum permeability is low and the constant permeability is excellent under a high magnetic field. However, in a case where heat treatment is performed with respect to the power magnetic core to which the resin is added as the insulating material, when a heat treatment temperature is set to be too high, the resin is apt to be deteriorated and decomposed and thus deterioration in an insulation property is caused. Therefore, the heat treatment temperature is set to be lower than a heat resistant temperature (approximately 300° C.) of the resin, and thus removal of strain becomes incomplete. Therefore, the hysteresis loss may be not reduced sufficiently and thus the core loss becomes high.

On the other hand, in a case where the powder magnetic core is manufactured by using only iron-based soft magnetic powders on which a phosphate-based insulating layer is formed without adding a resin, the powder magnetic core may be subjected to high-temperature heat treatment and the low core loss may be expected. In this case, as the heat treatment temperature increases, a permeability characteristic under a high magnetic field decreases largely with respect to the maximum permeability. Therefore, the constant permeability characteristic property deteriorates. To apply the core that is inferior in the constant permeability characteristic to the reactor, a design of increasing the number of gaps so as to make a gap, which is provided to the core, thick is necessary, but the design of this core causes increase in loss, increase in noise, and a large size of the reactor, and particularly, it is not preferable for a use such as an in-vehicle use in which fuel efficiency is requested or a mounting space is limited.

Therefore, an object of the present invention is to provide a powder magnetic core in which securing of a constant permeability characteristic under a high magnetic field and decrease in core loss are compatible with each other, and a method for producing the powder magnetic core.

### Solution to Problem

According to an aspect of the present invention, there is provided a powder magnetic core including an insulating layer containing a particulate metal oxide between metal powders, wherein the insulating layer contains Ca, P, O, Si, and C as elements. In addition, it is preferable that the insulating layer contain a calcium phosphate and a silicon oxide.

In this case, the insulating layer contains the particulate metal oxide, calcium phosphate, and a silicon oxide, and is formed in such a manner that the insulating layer surrounds a metal powder while being strongly bonded to the metal powder. Therefore, a powder magnetic core, in which the core loss is suppressed without deteriorating a constant permeability, may be obtained. In addition, as a method of improving a constant permeability characteristic, there is a method in which a metal oxide powder serving as a filler is added to a coated metal powder including an insulating layer containing a phosphate. In this case, there is a disadvantage in that a density of the powder magnetic core is decreased due to the presence of the filler. In contrast to this, in the powder magnetic core of the present invention, the powder magnetic core may be formed by only the coated metal powder that is provided with a composite insulating layer including the metal oxide. Therefore, a powder magnetic core having high strength may be provided. Due to the high strength of the powder magnetic core, an application range of the powder magnetic core becomes broad from a viewpoint of an in-vehicle component.

It is preferable that a mean particle size of the metal oxide be 10 to 350 nm. When a metal oxide having a large particle size is used, an insulation property tends to be excellent. If a metal oxide having a small particle size is used, when a molded body is formed, the strength or density of the molded body tends to increase. Furthermore, metal oxides that have a different particle size may be used in combination from a viewpoint of improving a coverage factor of a surface of a metal powder, and a viewpoint of making a metal oxide layer relatively dense. When a fine metal oxide particulate is present between relatively large metal oxides that are deposited on the surface of the metal powder, an insulating material may be formed in a high density. In addition, at a convex portion and a curved portion of the surface of the metal powder, it is difficult to form a uniform film of a metal oxide having a particle size of 100 nm or more. At the convex portion and the curved portion at which it is difficult to form the film of the metal oxide, it is preferable to use a metal oxide having a particle size less than 100 nm, and more preferably 50 nm or less, thereby improving uniformity of a film.

It is preferable that a specific resistivity of the powder magnetic core be 10,000 μΩcm or more. In addition, it is more preferable that the specific resistivity be 15,000 to 20,000 μΩcm or more, and still more preferably 20,000 μΩcm. In a powder magnetic core having the specific resistivity less than 10,000 μΩcm, there is a tendency that eddy current loss (intergranular eddy current loss) under an alternating current of 5 kHz or more increases significantly.

It is preferable that in the powder magnetic core, core loss at 0.1 T and 5 kHz be 70 kW/m³ or less, and the maximum permeability μmax be 60 to 150. In addition, it is preferable that the core loss at 0.1 T and 10 kHz be 150 kW/m³ or less, and the maximum permeability μmax be 60 to 150. In addition, it is preferable that the core loss at 0.1 T and 20 kHz be 400 kW/m³ or less, and the maximum permeability μmax be 60 to 150.

According to another aspect of the invention, there is provided a method for producing the powder magnetic core. The method includes a step of reacting an aqueous solution containing a calcium ion and a phosphate ion with a metal powders containing iron as main component in the presence of a metal oxide to form an insulating layer on a surface of the metal powders; a step of bringing an organosilicon compound into contact with a coated metal powders on which the insulating layer is formed to locate the organosilicon compound on a surface of or inside of the insulating layer so as to manufacture a coated metal powder; and a step of compressing the coated metal powders at a pressure of 980 to 1480 MPa and annealing at a temperature of 600° C. or higher. When the coated metal powders are subjected to the heat treatment at a high temperature of 600° C. or higher, low core loss of the obtained powder magnetic core may be realized.

It is preferable that annealing be performed under an H₂ or N₂ atmosphere during production of the powder magnetic core. In this way, when annealing is performed under a reducing gas or inert gas atmosphere, an insulation property of the powder magnetic core that is produced is increased. The reason is not clear, but the present inventors assume that this is because a siloxane coupling (—Si—O—Si—) derived from an organosilicon compound is cleaved due to annealing, and then changes to a silanol group.

### Advantageous Effects of Invention

According to the present invention, it is possible to provide a powder magnetic core in which decrease in core loss is achieved while a constant permeability characteristic is maintained, and a method of producing the powder magnetic core.

### BRIEF DESCRIPTION OF DRAWINGS

FIG. 1 is a schematic diagram illustrating a cross-sectional structure of a powder magnetic core.

FIG. 2 is a view illustrating a SEM photograph of a powder magnetic core that is obtained in Example 1 and a result of EDX element mapping of Fe in the powder magnetic core.

FIG. 3 is a view illustrating a result of EDX element mapping of the powder magnetic core that is obtained in Example 1.

### DESCRIPTION OF EMBODIMENTS

Hereinafter, preferred embodiments of the present invention will be described in detail. For easy understanding of description, in the respective drawings, like reference numerals will be given to like parts having substantially the same functions, and redundant description thereof will be omitted. In addition, dimensions of the respective drawings are exaggerated for explanation, and these are not necessarily coincident with an actual proportion.

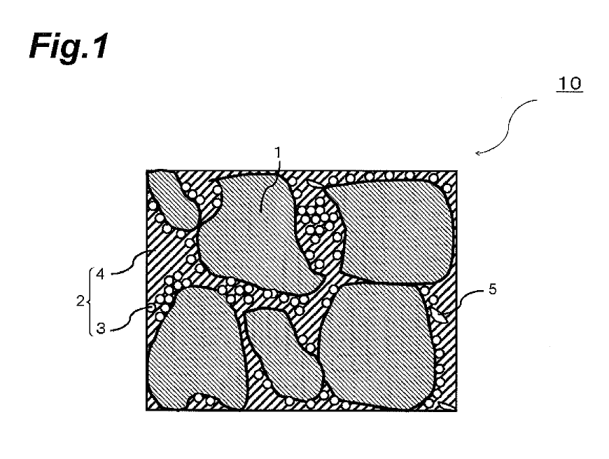

FIG. 1 shows a schematic diagram illustrating a cross-sectional structure of a powder magnetic core. As shown in FIG. 1, a powder magnetic core 10 in this embodiment includes a plurality of metal powders 1, and an insulating layer 2 that is present between the metal powders 1. The insulating layer 2 includes a particulate metal oxide 3 and an insulating material 4. The insulating layer 2 contains Ca, P, O, Si, and C as elements. In addition, it is preferable that the insulating layer 2 contain calcium phosphate and silicon oxide, and it is more preferable that the calcium phosphate make up the insulating material 4 and the silicon oxide make up the particulate metal oxide 3. In addition, the powder magnetic core 10 includes pores 5 that remain during compressing and annealing coated metal powder to be molded.

Each of the coated metal powders to produce the powder magnetic core 10 is a coated metal powder that includes a metal powder, and an insulating layer that is formed on a surface of the metal powder and that is formed from calcium phosphate and a metal oxide. The coated metal powder contains an organosilicon compound on a surface of the insulating layer or inside the insulating layer. Therefore, when coated metal powders are heated and compressed to produce a powder magnetic core, the insulating layer 2 is formed to cover the metal powders 1 while being strongly bonded to the metal powders 1. As a result, an insulation property of the powder magnetic core 10 is secured, and thus suppression of core loss is realized while securing a constant permeability characteristic.

Here, in this embodiment, a layer that is formed on a surface of the metal powder and is formed from the calcium phosphate and the metal oxide is referred to as an “insulating layer”, and an insulating layer containing the organosilicon compound on the surface of the insulating layer or inside the insulating layer is referred to as an “organosilicon treatment insulating layer”. Furthermore, in regard to the insulation layer, originally, it is ideal that powder particles of calcium phosphate or the like that are contained in the insulating layer are formed for each powder. However, actually, a layer may be formed in a state in which several particles are solidified, and even in this state, there is no problem regarding a characteristic aspect.

A calcium phosphate layer serves as a binder that fixes the metal oxide to the metal particle, but a crystal structure of the calcium phosphate is hard and thus the calcium phosphate layer on the surface of the metal powder 1 may be broken due to pressing treatment during a molding process. Therefore, in a case where the calcium phosphate layer is broken, a layer of the metal oxide 3 is introduced into the calcium phosphate layer due to a pressure of the pressing treatment and has a function of recovering the calcium phosphate layer.

The organosilicon treatment insulating layer has a function of preventing a particle of the metal oxide 3 from being detached from an insulating layer that is formed from only an inorganic material. An example of a silicone resin, which is very suitable as the organosilicon compound, is an organic insulating material that is excellent in heat resistance. Therefore, when the organosilicon treatment insulating layer is provided on the surface of the metal powder, heat treatment at a high temperature of approximately 600° C. may be performed, and thus low core loss of the powder magnetic core that is obtained may be realized. In a coated metal powder provided with an insulating layer formed from only phosphate, the heat treatment temperature was limited to approximately 500 to 550° C. In addition, the silicone resin may form a film that is excellent in flatness, and thus the insulating film is not detached or broken due to the pressure of the pressing treatment, thereby obtaining a preferable powder magnetic core. Hereinafter, respective constituent elements are sequentially described.

The coated metal powder has the above-described configuration, but it is preferable for the coated metal powder to have ferromagnetism and to exhibit a high saturation magnetic flux density. As the metal powder, a metal powder containing iron as a main component is preferable. Here, the metal powder containing iron as a main component represents a powder that is formed from pure iron, and a powder that is formed from an iron alloy in which in the metal content, iron has the highest content. As the metal powder, an iron powder, a silicon steel powder, a Sendust powder, a permendur powder, an iron-based amorphous magnetic alloy powder (for example, Fe—Si—B-based), and a soft magnetic material such as a permalloy powder may be preferably used. These powders may be used alone or in combination of two or more kinds. Among these, the iron powder is preferable because the pure iron is excellent in magnetic characteristics and is available cheaply. A composition of this metal powder is not particularly limited, but the pure iron powder, Fe—Si powder, and the like are representative. The invention relating to this embodiment is effective for the pure iron powder, particularly, a water atomized powder having a distorted shape, and the like. Generally, the metal powder containing iron as a main component includes 0 to 10% by mass of Si on the basis of 100% by mass of the total mass of the metal powder, and a remainder. The remainder includes (1) Fe that is a main component, (2) modifying elements such as Al, Ni, and Co that are added to improve magnetic characteristics, and (3) inevitable impurities.

Examples of the inevitable impurities include an impurity contained in a raw material (molten metal) of the metal powder, an impurity that is mixed in during powder forming, and the like. These impurities are elements that are difficult to remove due to a cost aspect or a technical aspect. In the case of the metal powder relating to the present invention, for example, C, S, Cr, P, Mn, and the like may be exemplified. In addition, naturally, a kind of basic elements (Fe, Co, Ni, Si, and the like) and a composition thereof are important for the metal powder, and thus a proportion of the modifying elements or the inevitable impurities is not particularly limited.

In a case where the iron powder is adopted as the metal powder, the pure iron powder is particularly preferable because the pure iron powder is excellent in a saturation magnetic flux density, permeability, and compressibility. Examples of the pure iron powder include an atomized iron powder, a reducing iron powder, an electrolytic iron powder, and the like. For example, 300 NH manufactured by Kobe Steel, Ltd, JIP-MG270H or JIP-304AS manufactured by JFE Steel Corporation, and an atomized pure iron powder (trade name: ABC100.30) manufactured by Hoganas AB, and the like may be exemplified.

A method of producing the metal powder does not matter. A crushed powder or an atomized powder is possible, and any one of the atomized powder, a water atomized powder, a gas atomized powder, and a gas and water atomized powder is possible. The water atomized powder has the most preferable availability and is cheap. The water atomized powder has a distorted particle shape, and thus easily improves the mechanical strength of a green compact that is obtained by compression molding the water atomized powder, but it forms a uniform insulating layer with difficulty and it is difficult to obtain a high specific resistivity. On the other hand, the gas atomized powder is a pseudo-spherical powder having an approximately spherical shape. Since the shape of each particle is approximately a spherical shape, when soft magnetic powders are compression-molded, an aggression property between respective powder particles becomes low, and thus breakage and the like of the insulating layer is suppressed. Therefore, it is easy to obtain a powder magnetic core having a high specific resistivity in a stable manner.

In addition, since the gas atomized powder is composed of particles having an approximately spherical shape, a surface area thereof is smaller than that of the water atomized powder or the like that has a distorted particle shape. Therefore, even when the total amount of particulates making up the organosilicon treatment insulating layer is the same, when using the gas atomized powder, a relatively thick insulating layer may be formed, and thus it is easy to further reduce eddy current loss. Conversely, an insulating layer having the same film thickness is provided, the total amount of the organosilicon treatment insulating layer may be reduced and thus a magnetic flux density of the powder magnetic core may be increased. Furthermore, since in the gas atomized powder, a grain size in the powder particles is large, a coercive force becomes small and thus reduction in hysteresis loss is easily realized. Therefore, when using a pseudo-spherical powder like the gas atomized powder, improvement in magnetic characteristics and reduction in core loss may be compatible with each other. Naturally, the soft magnetic powder may be a powder other than the atomized powder, and for example, may be a crushed powder that is obtained by crushing an alloy ingot using a ball mill or the like. When this crushed powder is subjected to a heat treatment (for example, annealing at 800° C. or more in an inert atmosphere), a grain size may be enlarged.

As the metal powder, a metal powder, which is treated with phosphoric acid to prevent oxidation, may be used. When using the metal powder that is subjected to this treatment in advance, it is possible to prevent a surface of the metal powder from being oxidized. The phosphoric acid treatment may be performed by a method disclosed in Japanese Unexamined Patent Application Publication No. 7-245209, Japanese Unexamined Patent Application Publication No. 2000-504785, and Japanese Unexamined Patent Application Publication No. 2005-213621, and a metal powder that is commercially available on the market as a metal powder that is treated with phosphoric acid may be used.

A particle size of the metal powder is not particularly limited, and is appropriately determined depending on a use or requested characteristics of the powder magnetic core. Generally, the particle size may be selected in a range of 1 to 300 μm. When the particle size is 1 μm or more, there is a tendency that the powder magnetic core becomes easy to be molded at the time of producing the same, and when the particle size is 300 μm or less, it is possible to suppress an increase of an eddy current of the powder magnetic core and there is a tendency that the calcium phosphate may be easily formed. In addition, as a mean particle size (calculated by a sieve analysis method), 50 to 250 μm is preferable. A form of the metal powder is not limited, and a powder with a spherical form or a massive form, or a flat-shaped powder that is processed to be flat by a known method or machining processing may be used.

Next, the organosilicon treatment insulating layer will be described. The film thickness of the organosilicon treatment insulating layer is preferably 10 to 1,000 nm, more preferably 30 to 900 nm, and still more preferably 50 to 300 nm. When the film thickness of the organosilicon treatment insulating layer is too small, the specific resistivity of the powder magnetic core becomes small and thus the core loss cannot be reduced sufficiently. On the other hand, when the film thickness and the like of the organosilicon treatment insulating layer are too large, a decrease in magnetic characteristics of the powder magnetic core may be caused. Hereinafter, respective configurations of the calcium phosphate, the metal oxide, and the silicon oxide will be sequentially described.

The calcium phosphate that covers the surface of the metal powder mainly has a function as an insulating film of the metal powder. In addition, when the calcium phosphate is formed, a metal oxide to be described later may be formed on the surface of the metal powder. From this viewpoint, it is preferable that the calcium phosphate have a film structure covering the surface of the metal powder as a layer state. The insulating film formed from the calcium phosphate may be formed on any powder as long as the powder is a metal powder.

In regard to a degree of coating the metal powder with the calcium phosphate, a part of metal powder may be exposed, but it is preferable that a coverage factor be high because, a specific resistivity value (index of an insulation property) of the powder magnetic core at the time of molding the powder magnetic core is raised with a high coverage factor, and a metal oxide or alkoxysilane that is described later is easily adhered to the metal powder, and as a result, a transverse rupture strength is also improved. Specifically, it is preferable that 90% or more of the surface of the metal powder be coated with two or more kinds of inorganic materials including the calcium phosphate and the metal oxide, more preferably 95% or more, and still more preferably the entirety of the surface (approximately 100%).

It is preferable that the thickness of the insulating film formed from the calcium phosphate be 10 to 1,000 nm, and more preferably 20 to 500 nm. When the thickness is 10 nm or more, there is a tendency of obtaining an insulation effect, and when the thickness is 1,000 nm or less, a density of a molded body is not decreased greatly.

It is preferable that an amount of the calcium phosphate that is formed on the surface of the metal powder be 0.1 to 1.5 parts by mass on the basis of 100 parts by mass of the metal powder, and more preferably 0.4 to 0.8 parts by mass. When the amount is 0.1 parts by mass or more, improvement in an insulation property (specific resistivity) and an adhesion operation of the metal oxide to be described later may be obtained. When the amount is 1.5 parts by mass or less, when the metal powder is molded into a powder magnetic core, a decrease in a density of a molded body tends to be prevented. A mass of the calcium phosphate may be obtained by measuring a mass increase of the coated metal powder that is obtained.

Examples of the calcium phosphate include monobasic calcium phosphate {Ca(H₂PO₄)₂.0 to 1 H₂O}, dibasic calcium phosphate (anhydride) (CaHPO₄), dibasic calcium phosphate {CaHPO₄.2H₂O}, tribasic calcium phosphate {3Ca₃(PO₄)₂.Ca(OH)₂}, tricalcium phosphate {Ca₃(PO₄)₂}, α-type tricalcium phosphate {α-Ca₃(PO₄)₂}, β-type tricalcium phosphate {β-Ca₃(PO₄)₂}, hydroxyapatite {Ca₁₀(PO₄)₆(OH)₂}, tetracalcium phosphate {Ca₄(PO₄)₂O}, calcium pyrophosphate (Ca₂P₂O₇), calcium dihydrogen pyrophosphate (CaH₂P₂O₇). Among these, the hydroxyapatite that is excellent in heat resistance is preferable. A heat resistant temperature of the hydroxyapatite is 1000° C. or higher. When the coated hydroxyapatite is used as an insulating layer of the metal powder, heat treatment at a high temperature of approximately 600° C. may be performed, and thus low core loss of a powder magnetic core that is obtained is realized. In addition, since the hydroxyapatite has an Off group in a structure, reactivity with a metal oxide and alkoxysilane is excellent.

The hydroxyapatite is one type of calcium phosphate, and is expressed by a chemical formula: Ca₁₀(PO₄)₆(OH)₂. In regard to the hydroxyapatite shown in this embodiment, a part in a structure thereof may be substituted with other elements. In the case of precipitating the hydroxyapatite as calcium phosphate, a stoichiometric compositional formula of the hydroxyapatite that is obtained is Ca₁₀(PO₄)₆(OH)₂, but most of the hydroxyapatite has an apatite structure, and as long as this structure may be maintained, a nonstoichiometric composition like a Ca-deficient hydroxyapatite is possible. That is, in the present invention, it is considered that hydroxyapatite having a nonstoichiometric composition like the Ca-deficient hydroxyapatite is included in the above-described hydroxyapatite. Specifically, theoretical hydroxyapatite is formed in a molar ratio of Ca/P=1.66, but Ca/P may be 1.4 to 1.8.

In addition, a part of ions in a structure of the hydroxyapatite may be substituted with other elements within a range not deteriorating properties. An apatite compound represented by the hydroxyapatite is a composition expressed by the following general formula (I), and various compound combinations are present through substitution of M²⁺, ZO⁴⁻, and X⁻. A case in which X⁻ is OH⁻ is particularly referred to as hydroxyapatite.

M₁₀(ZO₄)₆X₂ (I)

In the general formula (I), an ion of metal, which may be substituted with calcium, enters a position of M²⁺ that yields a cation, and specifically ions of sodium, magnesium, potassium, aluminum, scandium, titanium, chromium, manganese, iron, cobalt, nickel, zinc, strontium, yttrium, zirconium, ruthenium, rhodium, palladium, silver, cadmium, indium, tin, antimony, tellurium, barium, lanthanum, cerium, praseodymium, neodymium, samarium, europium, gadolinium, terbium, dysprosium, holmium, erbium, thulium, ytterbium, lutetium, hafnium, platinum, gold, mercury, thallium, lead, bismuth, and the like may be exemplified. In addition, PO₄³⁻, CO₃²⁻, CrO₄³⁻, AsO₄³⁻, VO₄³⁻, UO₄³⁻, SO₄²⁻, SiO₄⁴⁻, GeO₄⁴⁻, or the like enters a position of ZO₄⁻. OH⁻, a halide ion (F⁻, Cl⁻, Br⁻, and I⁻), BO²⁻, CO₃²⁻, O²⁻, or the like enters a position of X⁻. In addition, an ion that is substituted for M²⁺, ZO₄⁻, and X⁻ may be one kind or two kinds or more.

Here, it is preferable that the X be OH⁻ or F⁻. In the case of OH⁻, this is preferable because a hydrophilic property is increased, and thus a coating property with respect to the metal powder is excellent. In the case of F—, this is preferable because the strength is excellent. That is, it is particularly preferable to use hydroxyapatite: Ca₁₀(PO₄)₆(OH)₂ or fluoroapatite: Ca₁₀(PO₄)₆F₂ because when a powder magnetic core is made, an insulation property, a heat resistance, and dynamic characteristics are excellent.

In a case where calcium is substituted with another element, it is preferable that a substitution degree (the number of moles of another substituting atom/the number of moles of calcium) of each component by another element be 30% or less. Similarly, even in a case where the phosphate ion is substituted, it is preferable that the substitution degree be 30% or less, but in regard to a hydroxyl group, 100% of the hydroxyl groups may be substituted with another atom. The calcium phosphate may be obtained by allowing a solution containing calcium ions (in the case of containing atoms other than calcium atoms, an ion of the atom M that yields a cation other than the calcium ions and that will be described later) and an aqueous solution containing phosphate ions to react with each other. In a case where instead of the calcium ions, the ions of the atom M to be described later are allowed to react, calcium phosphate (an apatite compound or the like) in which a position of the atom M²⁺ that yields a cation is substituted with the ion of the atom M in general formula (I) may be obtained.

In the case of causing the phosphate compound to precipitate on a surface of metal powders, first, an aqueous solution, which contains calcium ions and which is subjected to a pH adjustment in an alkali environment, and metal powders are put into a vessel formed from metal, plastic, glass, or the like, and then an aqueous solution containing phosphate ions is added to the resultant mixture, thereby preparing an aqueous solution in which pH is 7 or more and the Ca/P ratio is in a preferable ratio after being mixed. After adjustment of the aqueous solution, it is preferable that mixing with the aqueous solution be performed while crushing the metal powders in the aqueous solution. In this case, an addition order may be changed, that is, the aqueous solution containing calcium ions may be added after the aqueous solution containing the phosphate ions and the metal powder are put into the vessel. In addition, the aqueous solution containing the phosphate ions, the metal powders, and the calcium ions may be put into the vessel at the same time.

The calcium ions are not particularly limited as long as the calcium ions are derived from a calcium compound. Specifically, for example, as a calcium ion source, a calcium salt of an inorganic base such as calcium hydroxide, a calcium salt of an inorganic acid such as calcium nitrate, a calcium salt of an organic acid such as calcium acetate, a calcium salt of an organic base, and the like may be exemplified. As a phosphoric acid source, phosphoric acid, phosphates such as ammonium dihydrogen phosphate and diammonium hydrogen phosphate, a condensed phosphoric acid such as a pyrophosphoric acid (diphosphoric acid) and a metaphosphoric acid may be exemplified. Among these phosphate compounds, any phosphoric compound may be used as long as this phosphate compound may be precipitated by allowing phosphoric acid and a salt (nitrate, acetate, carbonate, sulfate, chloride, or hydroxide) that yields a calcium ion to react in an aqueous solution. In addition, when considering impurities that are mixed in, it is particularly preferable to perform the precipitation by using the ammonium phosphate.

A reaction solution that is used during forming calcium phosphate on a surface of the metal powders is preferably in a neutral region to a base region. In this manner, the surface of the metal powders may be prevented from being oxidized, and among calcium phosphates, particularly, hydroxyapatite may be formed. It is preferable that the reaction solution during the formation have pH 7 or more, more preferably 8 to 11, and further more preferably 10 to 11 even when considering a solubility product of calcium phosphates. The hydroxyapatite dissolves in an acid region, and calcium phosphate other than hydroxyapatite is precipitated or mixed in in a neutral region. In addition, in the acid region, in accordance with a kind of metal powder, the hydroxyapatite may be oxidized and thus a part thereof is converted into an oxide, whereby a color may be changed. As a result, rust is generated and thus a color thereof is changed. Therefore, it is necessary for the pH of the reaction solution to be correctly adjusted by using a base such as aqueous ammonia, sodium hydroxide, and potassium hydroxide.

The crushing represents that during agitation, an aggregated portion of the metal powders is made to be loosened by using a shearing force that is applied to the metal powders due to friction or collision between metal powders. As a method of mixing an aqueous solution containing metal powders while crushing the metal powders, any one of methods using a planetary-mixer, a ball mill, a bead mill, a jet mill, a mix rotor, an evaporator, ultrasonic dispersion, and the like, which are capable of performing wet-type agitating (mixing), may be exemplified. Among these, it is preferable that the agitating be performed in accordance with a sample by adjusting the number of rotations by a mix rotator. Among the metal powders, an iron powder for a powder magnetic core is manufactured by an atomized method, and has a relatively wide particle size distribution. Therefore, a coarse iron powder that is insufficiently crushed or aggregation between iron powders is shown. When the coarse powder is mixed in, a decrease in magnetic characteristics or a density of a molded body may be caused. Therefore, it is possible to coat the metal powders with calcium phosphate while preventing the magnetic characteristics or the density of the molded body from being decreased by performing the agitating.

In regard to an agitating speed, even though the optimal rotation speed varies depending on the volume of a vessel that is used, the mass or the appearance volume of metal powders, or the volume of an aqueous solution, but for example, in a case where the volume of the vessel is 1,000 cm³, the weight of the metal powders that are used is 300 g, and the volume of the aqueous solution is 120 to 130% of the appearance volume of the metal powders, 30 to 300 rpm is preferable, and 40 to 100 rpm is more preferable. At this time, accompanying the rotation of the vessel, it is necessary for the metal powders to appropriately flow on an inner wall of the vessel. However, when the agitating speed is 300 rpm or higher, the metal powders do not flow and rotate while being adhered to the inner wall. As a result, the agitation is not performed in an effective manner. On the other hand, when the agitating speed is lower than 30 rpm, the vessel rotates too slowly, and thus the metal powder temporary stays on the bottom position (the lowest position during agitation) of the vessel due to their own weight, and thus the agitation is not performed at all.

Even when a reaction temperature during forming calcium phosphate on a surface of the metal powders is room temperature, there is no particular problem. However, when the temperature is raised, the reaction is promoted and thus a time that is necessary for the formation may be shortened. As the reaction temperature, 50° C. or higher is preferable, and 70° or higher is more preferable.

A reaction time during forming the calcium phosphate on the surface of the metal powders is different depending on the concentration of an aqueous solution containing calcium ions and the concentration of an aqueous solution containing phosphate ions. The concentrations of the solutions containing respective ions are preferably in a range of 0.003 to 1.0 M, respectively. The concentrations of the solutions containing respective ions are preferably in a range of 0.001 to 2.0 M, respectively, and more preferably in a range of 0.1 to 1.0 M. A reaction time in this case is preferably 1 to 10 hours, and more preferably 2 to 5 hours. In the case of 2.0 M or more, the metal powders easily aggregate with each other, and thus a low density is problematic when a molded body is produced. On the other hand, in the case of 0.01 M or less, the reaction time is lengthened more than necessary, and thus uniform coating of the metal powder may be difficult depending on a selected material. In addition, when the reaction time is short, for example, for approximately 1 to 10 minutes, the intended calcium phosphate is insufficiently generated on the surface of the metal powders, and thus a decrease in a yield rate and deficiency of insulation property (specific resistivity) are caused.

As an amount of an aqueous solution during forming the calcium phosphate on the surface of the metal powders, an amount with which the metal powders may effectively flow together with the rotation of the vessel is necessary. Therefore, it is preferable that the amount be 100 to 200% of the appearance volume with metal powders that are used, more preferably 110 to 140%, and still more preferably 120 to 130%.

Next, a metal oxide will be described. During forming the calcium phosphate on the surface of the metal powders in water or after forming the calcium phosphate, the metal oxide relating to this embodiment is added to the aqueous solution, thereby forming the metal oxide on the surface of the metal powders. The metal oxide may be formed either on the surface of the metal powders or on the calcium phosphate. When a uniform insulating layer of an inorganic material is formed by using the above-described calcium phosphate and the metal oxide, a high specific resistivity may be obtained.

The metal oxide may be used in a powder form. A material that is obtained by dispersing the metal oxide in a slurry state may be preferably used. That is, it is preferable that the metal oxide be dispersed in a solvent (water or an organic solvent) without being aggregated. In a step of forming the metal oxide on the surface of the metal powder, the addition of the metal oxide may be performed during forming the calcium phosphate or after this formation. This means that the coating of the metal powders with the calcium phosphate is performed using water as a solvent, and thus a sequence of dropping the metal oxide is not particularly limited. When the metal oxide is added during the formation, the calcium phosphate and the metal oxide are mixed, and thus the calcium phosphate and the metal oxide are uniformly distributed over the entirety of the iron powders, and a dense layer is formed. On the other hand, the metal oxide is added after forming the calcium phosphate layer, a fine metal oxide film is formed on the surface of the calcium phosphate layer. Particularly, the metal oxide is adhered in a concentrated manner to a surface portion on which unevenness, which easily causes cracking at the time of producing a molded body, is formed, and thus an effect as a buffer material is relatively increased.

Examples of the metal oxide include aluminum oxide, titanium oxide, cerium oxide, yttrium oxide, zinc oxide, silicon oxide, tin oxide, copper oxide, holmium oxide, bismuth oxide, cobalt oxide, indium oxide, and the like. These metal oxides may be used alone or in combination of two or more kinds. In addition, this metal oxide may be added in a powder state, but it is preferable to add the metal oxide in a slurry state. Intended metal oxide powders are dispersed in an appropriate solvent (water or an organic solvent) and the resultant dispersed mixture is used, thereby forming a uniform particulate film.

A method of dispersing the metal oxide is not particularly limited, but specifically, a crushing method using a device such as a bead mill, and a jet mill, an ultrasonic dispersion, and the like may be exemplified. In addition, a commercially available product as a slurry may be used as is. Examples of the form of the metal oxide include various forms such as a spherical form and a potbelly form, but the form is not particularly limited. As a specific product of a slurry product, NanoTek Slurry series manufactured by CI Kasei Co., Ltd., Quartron PL series or SP series that are manufactured by FUSO CHEMICAL CO., LTD., Snowtex series (colloidal silica and organosol), alumina sol, and Nano-Use that are manufactured by Nissan Chemical Industries, Ltd., Admafine manufactured by ADMATECHS CO., LTD., and the like may be exemplified.

As a particle size of the metal oxide, various sizes are possible, but a sub-micron particle size or less is preferable for a film forming property. An (mean) particle size of the metal oxide may be measured by instrumental analysis such as a dynamic light scattering method and a laser diffraction method. In addition, the (mean) particle size may be measured by directly observing fine metal oxide formed on the surface of the calcium phosphate using an electron microscope such as a SEM, an optical microscope, or the like. When directly observing, for example, ten metal oxide particles are arbitrarily selected in one sheet of a scanning electron microscope photograph, measurement values of the respective ten metal oxide particles are obtained, and the sum of the respective measurement values is divided by ten and this resultant value is referred to as an “mean” particle size. Hereinafter, it is simply described as a particle size.

It is preferable that the particle size of the metal oxide be 10 to 350 nm as a particle size. As a metal oxide having a large particle size is used, an insulation property tends to be excellent. As a metal oxide having a small particle size is used, when a molded body is formed, the strength and a density of the molded body tend to increase. Furthermore, metal oxides that have a different particle size may be used in combination from a viewpoint of improving a coverage factor of the surface of metal powders, and a viewpoint of making a metal oxide layer relatively dense. When a metal oxide particulate is present between relatively large metal oxides that are deposited on the surface of the metal powders, an insulating material may be formed with a high density. In addition, at a convex portion and a curved portion of the surface of the metal powders, it is difficult to form a uniform film of a metal oxide having a particle size of 100 nm or more. At the convex portion and the curved portion at which it is difficult to form the film of the metal oxide, it is preferable to use a metal oxide having a particle size less than 100 nm, and more preferably 50 nm or less, thereby improving uniformity of a film.

The solvent that disperses the metal oxide is not particularly limited, and specific examples thereof include alcohol-based solvents represented by methanol, ethanol, isopropyl alcohol, and the like, a ketone-based solvent represented by acetone and methyl ethyl ketone, and an aromatic solvent represented by toluene. Furthermore, even when water is used, there is no problem.

In addition, it is preferable that an addition amount of the metal oxide be 0.05 to 2.0 parts by mass on the basis of 100 parts by mass of the metal powders that are used. When the addition amount is 0.05 parts by mass or more, there is a tendency that the metal powders may be uniformly coated with the metal oxide and thus an effect of improving an insulation property (specific resistivity) may be obtained. On the other hand, when the addition amount is 2.0 parts by mass or less, when being used as a powder magnetic core, there is a tendency that a density of a molded body is prevented from being decreased and thus transverse rupture strength of the powder magnetic core that is obtained is also prevented from being decreased.

Next, the organosilicon compound will be described. As the organosilicon compound, an alkoxysilane or a reaction product thereof, or a silicone resin may be exemplified, but the silicone resin is more preferable. It is preferable that the silicone resin contain at least one compound of (1), (2), and (3) described below. (1) A polyorganosiloxane containing a bifunctional siloxane unit (D unit) (for example, polydimethyl siloxane and polymethyl phenyl siloxane). (2) A mixture of a polyorganosiloxane containing at least one of a monofunctional siloxane unit (M unit), a trifunctional siloxane unit (T unit), and a tetrafunctional siloxane unit (Q unit) (for example, MQ resin including the M unit and Q unit), and a polyorganosiloxane including a bifunctional siloxane unit (D unit) (for example, polydimethyl siloxane and polymethyl phenyl siloxane) (this mixture may be a mixture having an adherence property at room temperature or a mixture in which the adherence property occurs when being heated). (3) A polyorganosiloxane containing at least one of a monofunctional siloxane unit (M unit), a trifunctional siloxane unit (T unit), and a tetrafunctional siloxane unit (Q unit), and a bifunctional siloxane unit (D unit, for example, dimethyl siloxane unit, methyl phenyl siloxane unit) (it is preferable that the number of D units be larger than the total number of M units, T units, and Q units). As the polyorganosiloxane, an organosiloxane containing at least one of a T unit and a Q unit, and a D unit is preferable.

As the silicone resin, a curable (particularly, thermosetting) silicone resin is preferable. A film formed from this silicone resin functions as an insulating film that covers a surface of an inorganic insulating material, but also as a binder that bonds constituent particles. A transformation temperature at which the silicone resin enters a gel state is different depending on a kind of silicone resin. Therefore, although not being specified, the transformation temperature is approximately 150 to 300° C. When heating is performed at this temperature, a silicone resin that is adhered to a particle surface of soft magnetic powders becomes a curable silicone resin film. In this silicone resin film, accompanying temperature increase, a siloxane bonding progresses. Therefore, entire crosslinking is obtained from partial crosslinking by performing a high-temperature annealing treatment such as annealing, and thus film strength is improved. In addition, since the film formed from the silicone resin is excellent in heat resistance, even when high-temperature heating such as annealing is performed with the powder magnetic core after being molded, the powder magnetic core is not broken and the above-described crosslinking further progresses, and thus bonding between particles of a magnetic core powder is enhanced.

The silicone resins are largely classified into a thermosetting type that condenses and is cured by heat, and a room-temperature curing type that is cured at room temperature. In the former, when heat is applied, a functional group reacts and thus a siloxane bonding occurs, and thereby crosslinking progresses. As a result, the silicone resin condenses and is cured. On the other hand, in the latter, the functional group reacts at room temperature due to a hydrolysis reaction and thus the siloxane bonding occurs, and thereby the crosslinking progresses. As a result, the silicone resin condenses and is cured. The number of functional groups of a silane compound of the silicone resin is from 1 to a maximum of 4. The number of functional groups of the silicone resin that is used in the present invention is not limited, but it is preferable to use silicones including bifunctional or tetrafunctional silane compounds because a crosslinking density increases.

As a kind of silicone resins, starting from resins, silane compounds, rubber-based silicone, silicone powders, organic modified silicon oil, a composite thereof, and the like are exemplified, and a type thereof is different depending on a use. In the present invention, any silicone resin may be used. It is preferable to use a resin-based coating silicone resin, that is, a straight silicone resin including only silicone, or a silicone resin for modification that includes silicone and an organic polymer (alkyd, polyester, epoxy, acryl, or the like) from viewpoints of heat resistance, weather resistance, humidity resistance, an electrical insulation property, and simplicity of coating.

As the silicone resin, a methyl phenyl silicone resin in which a functional group on Si is composed of a methyl group or phenyl group is general. It is preferable that a lot of phenyl groups be contained because in this case, the heat resistance tends to increases. In addition, a ratio between a methyl group and phenyl group of the silicone resin and functionability may be analyzed by FT-IR or the like. Examples of the silicone resin that is used in the present invention include SH805, SH806A, SH840, SH997, SR620, SR2306, SR2309, SR2310, SR2316, DC12577, SR2400, SR2402, SR2404, SR2405, SR2406, SR2410, SR2411, SR2416, SR2420, SR2107, SR2115, SR2145, SH6018, DC6-2230, DC3037, DC3074, QP8-5314, and 217-Flake Resin that are manufactured by Dow Corning Toray Co., Ltd, YR3370, YR3286, TSR194, and TSR125R that are manufactured by Momentive Performance Materials Inc., KR251, KR255, KR114A, KR112, KR2610B, KR2621-1, KR230B, KR220, KR220L, KR285, K295, KR300, KR2019, KR2706, KR165, KR166, KR169, KR2038, KR221, KR155, KR240, KR101-10, KR120, KR105, KR271, KR282, KR311, KR211, KR212, KR216, KR213, KR217, KR9218, SA-4, KR206, KR5206, ES1001N, ES1002T, ES1004, KR9706, KR5203, KR5221, and X-52-1435 that are manufactured by Shin-Etsu Chemical Co., Ltd., and the like. In addition to these, other silicone resins may be used. In addition, a silicone resin obtained by modifying these materials or these raw materials may be used. Furthermore, a silicone resin, which is obtained by mixing two or more kinds of silicone resins in which a kind, a molecular weight, and a functional group are different in an appropriate ratio, may be used.

It is preferable to adjust an attached amount of a silicone resin film to be 0.01 to 0.8% by mass with respect to metal powders. When it is less than 0.01% by mass, an insulation property is deteriorated, and thus an electric resistance becomes low. On the other hand, when 0.8% by mass or more is added, powder after being heated and dried has a tendency to form a lump. In addition, a molded body that is manufactured by using lump-shaped powders is not likely to have a high density, and a film during molding is broken, whereby a decrease in eddy current loss becomes insufficient.

The silicone resin film may be formed by dissolving a silicone resin in petroleum-based organic solvents such as alcohols, ketones, toluene, and xylene, or the like, by mixing this resultant solution and iron powders, and by evaporating the organic solvent. A film forming condition is not particularly limited, but it is preferable to add 0.5 to 10 parts by mass of a resin solution, which is prepared in such a manner that a solid content is 0.5 to 5.0% by mass with respect to 100 parts by mass of magnetic powders coated with the insulating particles, and then mix the resultant material, and then dry the resultant mixture. When it is less than 0.5 parts by mass, there is a concern that the mixing may take a long time and the film may be non-uniform. On the other hand, when it exceeds 10 parts by mass, since an amount of solution is too much, there is a concern that the drying may take too much time or the drying becomes insufficient. The resin solution may be appropriately heated.

The thickness of the silicone resin film has a great effect on a decrease in a magnetic flux density. Therefore, 10 to 500 nm is preferable, and more preferably 20 to 200 nm. In addition, the total thickness of the inorganic insulating material and the silicone resin film is preferably 100 to 1,500 nm.

In regard to a step of drying the silicone resin, it is preferable to heat the silicone resin at a temperature at which an organic solvent that is used vaporizes and at a temperature lower than a curing temperature of the silicone resin so as to sufficiently vaporize the organic solvent. In regard to a specific drying temperature, the drying is performed at a temperature that is equal to or higher than a boiling temperature of each organic solvent. For example, as a specific example of the drying in the case of using a solvent such as ketones, drying by heating may be performed in a heating condition of 100 to 250° C. for 10 to 60 minutes. More preferably, the drying by heating may be performed at 120 to 200° C. for 10 to 30 minutes.

The drying process is performed to dry the resin film (remove the solvent) and preliminarily cure the silicone resin. In a powder onto which the silicone resin is applied, when the powder is vacuum-dried, a surface is tacky and thus a handling property is poor. Therefore, when the preliminary curing is performed as necessary, securement of flowability of the magnetic powder during molding and occurrence of cracking in a molded body may be suppressed. As a specific method, the magnetic powders on which the silicone resin film is formed are heated for a short time at a temperature near a curing temperature of the silicone resin. A difference between the preliminary curing and curing is that in the preliminary curing, powders are not bonded and solidified completely and are easily crushed, and conversely, in a high-temperature heating treatment process (annealing) that is performed after molding the powders, the resin is cured and powders are bonded and solidified, and thus the strength of the molded body is improved.

As described above, when the silicone resin is crushed after being subjected to the preliminary curing, it is possible to obtain powder that is excellent in flowability during being charged into a mold. When this preliminary curing is not performed, for example, powders are adhered to each other during the warm molding, and thus it is difficult to put the powders into the mold in a short time. In an actual process, an improvement in a handling property is very important, and it is found that a specific resistivity of a powder magnetic core that is obtained is improved by performing the preliminary curing. The reason is not clear, but it is considered to be because an adhesion property with iron powders during being cured is increased. In addition, as necessary, after being dried, the powders may be made to pass through a sieve having an aperture of approximately 300 to 500 μm so as to remove aggregated lumps.

(Manufacturing of Powder Magnetic Core)

The powder magnetic core may be obtained by a manufacturing method including a step of compressing and annealing the above-described coated metal powders. Here, the method of producing the powder magnetic core may include a step of mixing a lubricant with the coated metal powders as necessary, and compressing and annealing the resultant mixture. That is, the powder magnetic core may be obtained by mixing a lubricant with the coated metal powders as necessary and by compressing and annealing the resultant mixture. In addition, the lubricant may be used in such a manner that the lubricant is dispersed in an appropriate dispersion medium to obtain a dispersed solution, and then this dispersed solution is applied on an inner wall surface (a wall surface that comes into contact with a punch) of a mold die, and is dried.

Prepared coated metal powders are formed into a molded body that is called a powder magnetic core through a filling step of filling the powders for a large magnetic core into a mold, and a molding step of compressing and molding the metal powders for a powder magnetic core. The compression molding of the coated metal powders (including the mixed powders), which are filled into the mold, for a powder magnetic core may be a general molding method in which an internal lubricant or the like is mixed with the powders, regardless of cold molding, warm molding and hot molding. However, it is more preferable to adopt a mold-lubricating warm compression molding method to be described later from a viewpoint of improving magnetic characteristics due to high densification. Due to this method, even when a molding pressure is set to be high, scuffing does not occur between an internal surface of the mold and the coated metal powders, and a taking-out pressure is not excessive, thereby suppressing a decrease in life time of the mold. In addition, a highly dense powder magnetic core may be produced in an industrial level not a test level.

As the lubricant, metallic soap such as zinc stearate, calcium stearate, and lithium stearate, long chain hydrocarbons such as wax, silicone oil, or the like may be used.

In regard to a degree of compression in the molding process, it is preferable that the molding pressure be set to 980 to 1480 MPa from a viewpoint of life time of the mold or productivity.

When the coated metal powders are subjected to compression molding, remaining stress or remaining strain occurs inside the coated metal powders. Therefore, to remove these, a molded body is suitably subjected to a heat treatment process (annealing) of heating and gradually cooling the molded body. Due to this heat treatment process, hysteresis loss is reduced. In addition, a powder magnetic core, which is excellent in flowability with respect to an alternating magnetic field or the like, may be obtained. In addition, the remaining strain or the like that is removed through the annealing process may be strain or the like that is accumulated inside the metal powders from before the molding process.

When the heat treatment temperature is high, the remaining strain or the like is effectively removed. At least partial breakage occurs even in an organosilicon treatment insulating layer that has the highest heat resistance. Therefore, it is preferable that the heat treatment temperature be determined by also considering a heat resistance in the organosilicon treatment insulating layer. For example, when the heat treatment temperature is set to 600 to 800° C., compatibility between the removal of the remaining strain and protection of the organosilicon treatment insulating layer may be realized. In consideration of an effect and economic efficiency, a annealing time is set to 1 to 300 minutes, and preferably 10 to 60 minutes.

As an atmosphere at the time of performing the heat treatment, a non-oxidizing atmosphere is preferable. For example, a vacuum atmosphere, an inert gas (N₂, Ar) atmosphere, or a reducing gas (H₂) may be exemplified. In addition, the reason why the heat treatment process is performed in the non-oxidizing atmosphere is that excessive oxidization of the powder magnetic core or magnetic powder making up the powder magnetic core is suppressed and a decrease in magnetic characteristics or electrical characteristics is suppressed. Specifically, generation of FeO or generation of a Fe₂SiO₄ layer may be exemplified.

The powder magnetic core that is manufactured by the above-described coated metal powders may be used for various electronic apparatuses such as a motor (particularly, a core or a yoke), an actuator, a reactor core, a transformer, an induction heater (IH), and a speaker. Particularly, in this powder magnetic core, a high magnetic flux density, and a decrease in hysteresis loss due to annealing or the like are realized. Furthermore, the powder magnetic core is applicable to an apparatus that is used in a relatively low frequency range, or the like.

### EXAMPLES

Hereinafter, the present invention will be described in more detail with reference to the following examples. In addition, the present invention is not limited to the examples.

### Production of Coated Metal Powder

### Example 1

1 kg of iron powders (ABC100.30, manufactured by Hoganas AB) that were classified to have a maximum particle size of 75 μm or less was added to 300 ml of water, 6 g of calcium phosphate shown in Table 1 was added to the iron powder while performing agitation, and the resultant mixture was agitated in a condition of 100 rpm×30 minutes to cause the calcium phosphate to be adhered to a surface of each of the iron powders (formation of a first layer). Subsequently, as an adhesion step of a metal oxide, colloidal silica (water dispersion slurry) shown in Table 1 was added in such a manner that an amount of SiO₂ became 8 g, and agitation was continuously performed for 30 minutes to perform the adhesion (formation of a second layer). Here, first, drying treatment was performed, and then agitation treatment with a silicone resin (KR311 manufactured by Shin-Etsu Silicone Corporation) was performed, and then drying treatment was performed to form a coated metal powder provided with an organosilicon treatment insulating layer. In addition, a phosphoric acid-coated powder, which was produced by performing only a phosphoric acid coating treatment to the same iron powder and by drying the treated iron powder, as the related art, and an insulation-treated powder (manufactured by Hoganas AB) commercially available on the market were prepared.

### Example 2

A coated metal powder was produced by the same method as Example 1 except that SiO₂ that was used for the second layer in Example 1 was changed to SiO₂ having a particle size of 125 nm.

### Example 3

A coated metal powder was produced by the same method as Example 1 except that SiO₂ that was used for the second layer in Example 1 was changed to Al₂O₃.

### Example 4

A coated metal powder was produced by the same method as Example 1 except that SiO₂ that was used for the second layer in Example 1 was changed to TiO₂.

### Example 5

A coated metal powder was produced by the same method as Example 1 except that SiO₂ that was used for the second layer in Example 1 was changed to ZrO₂.

### Example 6

A coated metal powder was produced by the same method as Example 1 except that SiO₂ that was used for the second layer in Example 1 was changed to Y₂O₃.

### Example 7

A coated metal powder was produced by the same method as Example 1 except that the hydroxyapatite (Ca₁₀(PO₄)₆(OH)₂) that was used for the first layer in Example 1 was changed to calcium phosphate (Ca(H₂PO₄)₂).

### Example 8

A coated metal powder was produced by the same method as Example 1 except that the hydroxyapatite (Ca₁₀(PO₄)₆(OH)₂) that was used for the first layer in Example 1 was changed to dicalcium phosphate (CaHPO₄).

### Example 9

A coated metal powder was produced by the same method as Example 1 except that the hydroxyapatite (Ca₁₀(PO₄)₆(OH)₂) that was used for the first layer in Example 1 was changed to β-type tricalcium phosphate (Ca₃(PO₄)₂).

### Example 10

A coated metal powder was produced by the same method as Example 1 except that the silicone resin (KR311, manufactured by Shin-Etsu Chemical Co., Ltd.) that was used for a third layer in Example 1 was changed to YR3286 manufactured by Momentive Performance Materials Inc.

### Example 11

A coated metal powder was produced by the same method as Example 1 except that the silicone resin (KR311, manufactured by Shin-Etsu Chemical Co., Ltd.) that was used for a third layer in Example 1 was changed to TSR194 manufactured by Momentive Performance Materials Inc.

### Example 12

A method of synthesizing a calcium phosphate layer that is the first layer in a wet type was reviewed.

14.2 g of calcium nitrate tetrahydrate (manufactured by Wako Pure Chemical Industries, Ltd) and 4.15 g of ammonium dihydrogen phosphate were dissolved in 150 g of pure water, respectively. Subsequently, 1 kg of iron powders (ABC 100 manufactured by Hoganas AB) having a maximum particle size of 75 μm or less, an aqueous solution of the calcium nitrate tetrahydrate, and an aqueous solution of ammonium dihydrogen phosphate were added into a plastic vessel, and aqueous ammonia was gradually added dropwise to adjust pH of the resultant aqueous solution to 9, thereby precipitating hydroxyapatite. Immediately after dropwise addition of the aqueous ammonia, the vessel was sealed, and agitation was performed at the number of rotations of 100 rpm for 30 minutes to form the hydroxyapatite on a surface of each of the iron powders. Subsequently, as an adhesion step of the metal oxide, colloidal silica (water dispersion slurry) having a particle size of 60 nm or more was added in such a manner that SiO₂ becomes 8 g, and agitation was performed again with the number of rotations of 100 rpm for 30 minutes. A coated iron powder that was obtained was subjected to filtering and drying treatment and was kneaded with a silicone resin (KR 311, manufactured by Shin-Etsu Silicone Corporation), and the resultant kneaded material was dried to produce a coated metal powder provided with an organosilicon treatment insulating layer.

### Example 13

A coated metal powder was produced by the same method as Example 12 except that SiO₂ having a particle size of 125 nm was used instead of SiO₂ having a particle size of 60 nm that was used for the second layer in Example 12.

### Comparative Example 1

In relation to Example 1, a coated metal powder in which only hydroxyapatite was formed on the surface of the metal powder as the first layer was produced.

### Comparative Example 2

In relation to Example 1, a coated metal powder in which only hydroxyapatite was formed as the first layer and only SiO₂ was formed as the second layer was produced.

### Comparative Example 3

Only phosphoric acid coating treatment was performed with respect to an iron powder (ABC 100.30, manufactured by Hoganas AB) that was classified to have a maximum particle size of 75 μm or less, and then the resultant coated iron powder was dried to produce a coated metal powder.

### Comparative Example 4

“Somaloy110i 1P” (manufactured by Hoganas AB) commercially available on the market was prepared.

[Method of Manufacturing Test Specimen for Transverse Rupture Strength Test]

15 g of powders for magnetic core that were obtained was weighed, lithium stearate that was dispersed in alcohol was applied to the inside of a mold having dimensions of 12 mm×34 mm, the powders for magnetic core were filled into the mold in a state in which the powders for magnetic core and the mold were heated to a temperature of 130° C., a plurality of transverse rupture strength test specimens (12×34×5 mm) having a density of 7.3 to 7.35 Mg/m³ were manufactured at a molding pressure of 980 to 1480 MPa by a 2000 kN Amsler type universal tester. The density was measured by using the Archimedes method in which the density is calculated from a dried weight and an underwater weight.

[Annealing Process]

A ring-molded body and the transverse rupture strength test specimens, which were manufactured, were subjected to heat treatment at a temperature of 650° C. for 30 minutes under an N₂ atmosphere using an atmosphere-adjusted induction annealing furnace, in which a rate of temperature increase was set to 10° C./min. These were cooled with furnace cooling after the annealing for 30 minutes, and a powder magnetic core was obtained.

[Measurement of Core Loss]

Core loss represents an excitation magnetic flux density and energy loss due to a frequency. When a material has low core loss, this indicates that this material has high efficiency.

Core loss measurement was evaluated using a SY-8232 manufactured by IWATSU TEST INSTRUMENTS CORPORATION. An inner diameter, an outer diameter, entire length dimensions, and a weight of the powder magnetic core were measured. After insulating paper was wrapped around a surface layer of the powder magnetic core, a winding coil for detection and a winding coil for excitation were provided. The number of windings of a copper wire for detection was set to 20 turns, and the number of windings of a copper wire for excitation was set to 60 turns, thereby producing test specimens. An excitation magnetic flux density was set to be constant such as 0.1 T, frequencies were set to 5 kHz, 10 KHz, and 20 kHz, respectively, and then the core loss was measured at each frequency.

[Measurement of Maximum Permeability]

Measurement of the maximum permeability was evaluated by using a B-H analyzer manufactured by Denshijiki Industry Co., Ltd. An inner diameter, an outer diameter, entire length dimensions, and a weight of the powder magnetic core were measured. After insulating paper was wrapped around a surface layer of the powder magnetic core, a winding coil for detection and a winding coil for excitation were provided. A copper wire for detection was set to have φ of 0.26 mm and was wound with 20 turns, and a copper wire for detection was set to have φ of 0.5 mm and was wound with 200 turns, thereby producing a ring test specimen.

The maximum value of a magnetizing force H was set to 10,000 A/m. The magnetizing force was changed, and a specific permeability was measured from variation in a magnetic flux density B. The maximum value of the permeability was set to the maximum permeability.

[Transverse Rupture Strength]

As a transverse rupture strength test, a three-point bending test was performed in conformity to JIS-Z-2248 by using an accurate universal tester (autograph). A distance between supporting points was set to 25.4 mm, and a pressurizing rate was set to 0.5 mm/min. Transverse rupture strength was obtained from the maximum test force.

[Specific Resistivity]

A specific resistivity value of the powder magnetic core that was obtained using powders for a magnetic core was measured on a press surface of a ring-shaped molded body after annealing using a four-probe measuring device. At this time, specific resistivity measurement was performed after removing a residue on a surface layer portion by polishing the press surface using polishing paper of No. 400 to 600 to exclude an effect of a lubricant that remains on the surface layer portion during molding and annealing.

[DC Biased Characteristic]

An DC biased Characteristic relates to a method of evaluating an inductance (L) at the time of applying a superimposed current (I) under an alternating current, and when an inductance value under the current that is applied is lower than an inductance value in a not-superimposing state (0 A), it is determined to be preferable. The inductance value varies depending on a core shape, a core weight, or the number of windings of the copper wire, and thus evaluation was performed in a state in which the core shape was set to constant dimensions of φ20×φ30×5 mm, the core weight was constantly set to 14.5 g, the copper wire was set to have q of 1.0 mm, and the number of windings was set to 20 turns. Evaluation was performed using an LCR meter LM-2101B manufactured by KOKUYO ELECTRIC CO., LTD, a frequency was set to 10 kHz, an application current was incremented by 1 A from a not-based state (0 A) for every 50 msec, the maximum application current was set to 30 A, and then an inductance was measured at each application current. A dropping rate of an inductance value at 30 A with respect to an inductance value at the time of not-superimposing was evaluated.

[Energy Dispersion Type X-Ray Analysis (EDX Analysis)

A cross-section of a molded body was polished under conditions in which an acceleration voltage was 6 kV, a discharge voltage was 4 kV, and a swing speed was 1 (no units) by using an ion milling device (E-3500, manufactured by Hitachi High Technologies Corporation), EDX element mapping analysis of a cross-section was performed under conditions in which an acceleration voltage was 15 kV, a deposition material was Pt—Pd, and an angle of inclination of a material was 0° C. by using an energy dispersion type analysis device (INCA Energy 350, manufactured by Oxford Instruments KK).

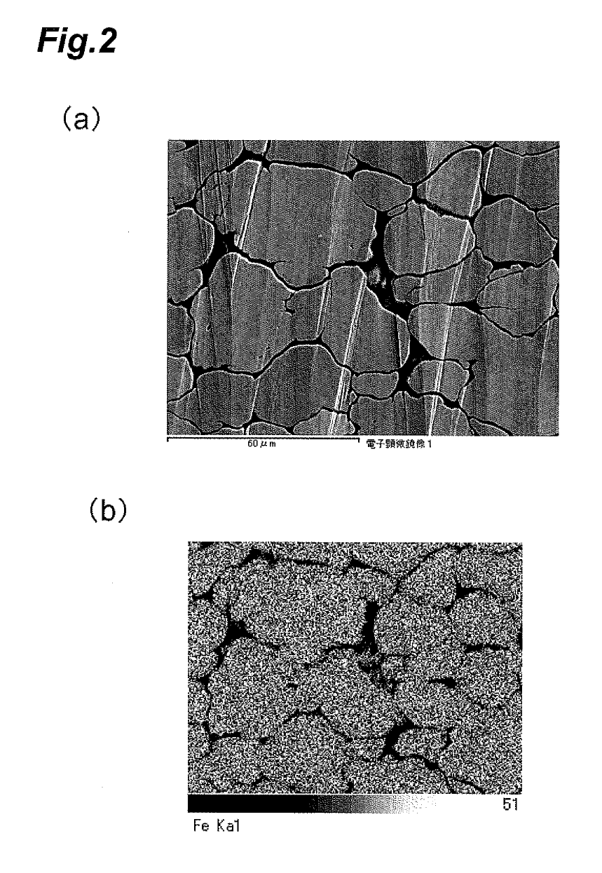

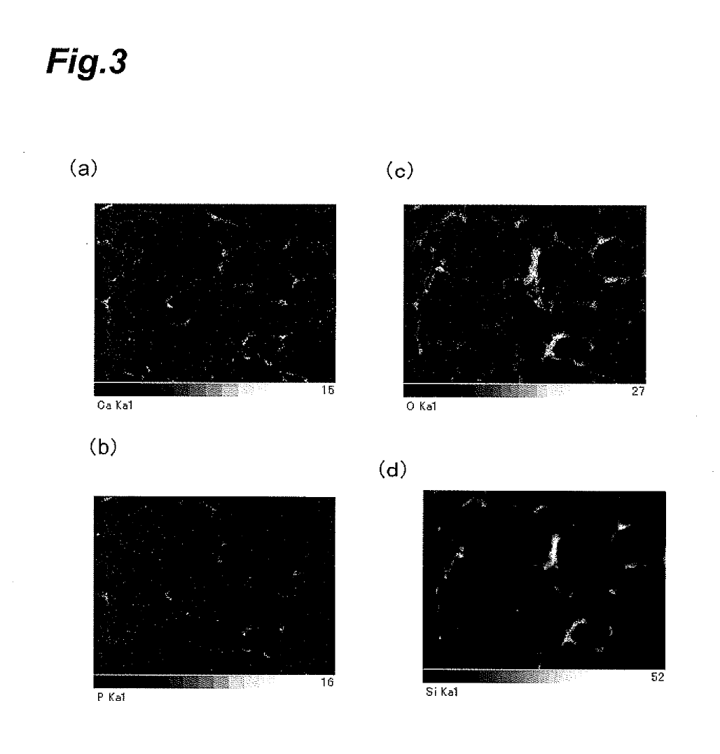

Evaluation results of the core loss, the maximum permeability, the transverse rupture strength, the specific resistivity, and the DC biased Characteristic in Examples 1 to 13 and Comparative Examples 1 to 4 are shown in Table 1. In addition, EDX analysis results of the powder magnetic core that was obtained in Example 1 are shown in FIG. 2. FIG. 2(a) is a SEM image of the powder magnetic core that was obtained in Example 1, and FIG. 2(b) shows FeEDX analysis results. EDX analysis results of Ca, O, P, and Si are shown in FIG. 3.

TABLE 1

| | | | | | | | | | | | DC biased | |
|---|---|---|---|---|---|---|---|---|---|---|---|---|
| | | | | | | | | | Transverse | | characteristic | |
| | | | | | Core loss (kW/cm³) | | | Maximum | rupture | Specific | 0 A→30 A | |
| | Composition of film | | | | Measurement | | | permeability | strength | resistivity | Dropping | |
| | | Second | | Density | frequency (kHz) | | | (μₘₐₓ) | [MPa] | [μΩcm] | rate | |
| | First layer | layer | Third layer | (Mg/m³) | 5 kHz | 10 kHz | 20 kHz | μmax | MPa | μΩcm | % | Remarks |
| Example 1 | Hydroxy-apatite | SiO₂ | Phenyl-based | 7.33 | 57 | 138 | 315 | 131 | 50 | 15300 | 45 | Second layer |
| | Ca₁₀(PO₄)₆(OH)₂ | 60 nm | KR311 manufactured by | | | | | | | | | Particle size is different |
| | | | Shin-Etsu Chemical Co., Ltd. | | | | | | | | | |
| Example 2 | Hydroxy-apatite | SiO₂ | Phenyl-based | 7.34 | 57 | 124 | 303 | 105 | 45 | 16800 | 40 | |
| | Ca₁₀(PO₄)₆(OH)₂ | 125 nm | KR311 manufactured by | | | | | | | | | |
| | | | Shin-Etsu Chemical Co., Ltd. | | | | | | | | | |
| Example 3 | Hydroxy-apatite | Al₂O₃ | Phenyl-based | 7.33 | 59 | 130 | 302 | 82 | 42 | 16300 | 42 | Second layer |
| | Ca₁₀(PO₄)₆(OH)₂ | 60 nm | KR311 manufactured by | | | | | | | | | Kind is different |
| | | | Shin-Etsu Chemical Co., Ltd. | | | | | | | | | |
| Example 4 | Hydroxyapatite | TiO₂ | Phenyl-based | 7.32 | 59 | 139 | 329 | 129 | 46 | 12600 | 46 | |
| | Ca₁₀(PO₄)₆(OH)₂ | 60 nm | KR311 manufactured by | | | | | | | | | |
| | | | Shin-Etsu Chemical Co., Ltd. | | | | | | | | | |
| Example 5 | Hydroxy-apatite | ZrO₂ | Phenyl-based | 7.32 | 65 | 140 | 377 | 138 | 38 | 11100 | 48 | |
| | Ca₁₀(PO₄)₆(OH)₂ | 60 nm | KR311 manufactured by | | | | | | | | | |
| | | | Shin-Etsu Chemical Co., Ltd. | | | | | | | | | |
| Example 6 | Hydroxyapatite | Y₂O₃ | Phenyl-based | 7.32 | 61 | 141 | 352 | 144 | 38 | 11800 | 49 | |
| | Ca₁₀(PO₄)₆(OH)₂ | 60 nm | KR311 manufactured by | | | | | | | | | |
| | | | Shin-Etsu Chemical Co., Ltd. | | | | | | | | | |
| Example 7 | Calcium | SiO₂ | Phenyl-based | 7.33 | 56 | 140 | 319 | 142 | 44 | 15000 | 47 | First layer |
| | phosphate | | KR311 manufactured by | | | | | | | | | Kind is different |
| | Ca(H₂PO₄)₂ | 60 nm | Shin-Etsu Chemical Co., Ltd. | | | | | | | | | |
| Example 8 | Dicalcium | SiO₂ | Phenyl-based | 7.33 | 57 | 142 | 331 | 136 | 42 | 14700 | 45 | |
| | phosphate | | KR311 manufactured by | | | | | | | | | |
| | (anhydride) | | Shin-Etsu Chemical Co., Ltd. | | | | | | | | | |
| | CaHPO₄ | 60 nm | | | | | | | | | | |
| Example 9 | β-type tricalcium | SiO₂ | Phenyl-based | 7.33 | 56 | 140 | 328 | 136 | 43 | 14800 | 45 | |
| | phosphate | | KR311 manufactured by | | | | | | | | | |
| | Ca₃(PO₄)₂ | 60 nm | Shin-Etsu Chemical Co., Ltd. | | | | | | | | | |
| Example 10 | Hydroxyapatite | SiO₂ | Methyl-based | 7.32 | 60 | 139 | 336 | 72 | 50 | 12300 | 41 | Third layer |
| | Ca₁₀(PO₄)₆(OH)₂ | 60 nm | YR3286 manufactured by | | | | | | | | | Kind is different |
| | | | Momentive Performance Materials Inc. | | | | | | | | | |
| Example 11 | Hydroxy-apatite | SiO₂ | Epoxy-based | 7.32 | 67 | 144 | 382 | 99 | 48 | 10800 | 46 | |
| | Ca₁₀(PO₄)₆(OH)₂ | 60 nm | TSR194 manufactured by | | | | | | | | | |
| | | | Momentive Performance Materials Inc. | | | | | | | | | |
| Example 12 | Hydroxyapatite | SiO₂ | Phenyl-based | 7.33 | 56 | 133 | 302 | 125 | 48 | 15800 | 43 | First layer |
| | Ca₁₀(PO₄)₆(OH)₂ | 60 nm | KR311 manufactured by | | | | | | | | | Wet-type synthesis |
| | | | Shin-Etsu Chemical Co., Ltd. | | | | | | | | | |
| Example 13 | Hydroxyapatite | SiO₂ | Phenyl-based | 7.33 | 55 | 122 | 298 | 102 | 40 | 17200 | 40 | |
| | Ca₁₀(PO₄)₆(OH)₂ | 125 nm | KR311 manufactured by | | | | | | | | | |
| | | | Shin-Etsu Chemical Co., Ltd. | | | | | | | | | |
| Comparative | Hydroxy-apatite | — | — | 7.34 | 108 | 245 | 732 | 248 | 45 | 5280 | 72 | First layer only |
| Example 1 | Ca₁₀(PO₄)₆(OH)₂ | | | | | | | | | | | |
| Comparative | Hydroxy-apatite | SiO₂ | — | 7.32 | 87 | 195 | 633 | 236 | 40 | 6090 | 68 | Second layer only |
| Example 2 | Ca₁₀(PO₄)₆(OH)₂ | 60 nm | | | | | | | | | | |

| | | | | | | | | | | |
|---|---|---|---|---|---|---|---|---|---|---|
| Comparative | Only phosphoric acid film | 7.33 | 82 | 169 | 514 | 254 | 50 | 7800 | 65 | Related art |
| Example 3 | | | | | | | | | | |
| Comparative | Somaloy110i 1P manufactured by Hoganas AB | 7.33 | 85 | 164 | 499 | 294 | 48 | 8800 | 78 | Commercially available Product |
| Example 4 | | | | | | | | | | |

Specimens in which the second layer (metal oxide) is composed of colloidal silica (SiO₂) and specimens in which the metal oxide is composed of Al₂O₃, TiO₂, ZrO₂, and Y₂O₃, respectively, exhibit preferable core loss value compared to a coated metal powder that is subjected to a common phosphoric acid coating treatment, and this value is a characteristic value that is approximately equal to a commercially available specimen, which is subjected to insulating coating. In regard to the maximum permeability μmax, specimens of examples exhibit the maximum permeability that is lower than that of a product that is insulation-treated by a phosphate film or a commercially available product. Therefore, it is expected that variation in the permeability with respect to a magnetic field tends to be small.

From a viewpoint of strength of the powder magnetic core that is obtained, a powder magnetic core that is provided with an organosilicon treatment insulating layer exhibits a preferable strength value, and this value is approximately equal to that of a coated metal powder that is coated with phosphate and a commercially available powder. In addition, a specific resistivity of the powder magnetic core provided with the organosilicon treatment insulating layer is higher compared to the related art, and thus stable core loss may be obtained at a high frequency domain.

In addition, as shown in FIG. 3, it was confirmed that Ca, P, O, and Si as elements are present in the insulating layer 2 of the powder magnetic core of Example 1.

### REFERENCE SIGNS LIST

1: Metal powder
2: Insulating layer
3: Metal oxide
4: Insulating material
10: Powder magnetic core

1. A powder magnetic core, comprising:
an insulating layer containing a particulate metal oxide between metal powders,
wherein the insulating layer contains Ca, P, O, Si, and C as elements.

2. The powder magnetic core according to claim 1,
wherein the insulating layer contains calcium phosphate and silicon oxide.

3. The power magnetic core according to claim 1,
wherein a mean particle size of the particulate metal oxide is 10 to 350 nm.

4. The powder magnetic core according to claim 1,
wherein a specific resistivity is 10,000 μΩcm or more.

5. The powder magnetic core according to claim 1,
wherein core loss at 0.1 T and 5 kHz is 70 kW/m³ or less, and the maximum permeability μmax is 60 to 150.

6. The powder magnetic core according to claim 1,
wherein core loss at 0.1 T and 10 kHz is 150 kW/m³ or less, and the maximum permeability μmax is 60 to 150.

7. The powder magnetic core according to claim 1,
wherein core loss at 0.1 T and 20 kHz is 400 kW/m³ or less, and the maximum permeability μmax is 60 to 150.

8. A method for producing the powder magnetic core according to claim 1, the method comprising:
a step of reacting an aqueous solution containing a calcium ion and a phosphate ion with a metal powders containing iron as main component in the presence of a metal oxide to form an insulating layer on a surface of the metal powder;
a step of bringing an organosilicon compound into contact with a coated metal powder on which the insulating layer is formed to locate the organosilicon compound on a surface of or inside of the insulating layer so as to manufacture coated metal powder; and
a step of compressing the coated metal powder at a pressure of 980 to 1480 MPa and annealing at a temperature of 600° C. or higher.

9. The method according to claim 8,
wherein the annealing is performed under an H₂ or N₂ atmosphere.
